(19) United States
(12) Patent Application Publication
(10) Pub. No.: US 2011/0032344 A1
(43) Pub. Date: Feb. 10, 2011

(54) DISPLAY APPARATUS FOR SWITCHING BETWEEN 2D AND 3D IMAGE DISPLAYING MODES

(75) Inventors: Yeon-Joo Choi, Suwon-si (KR); Cha-Won Hwang, Suwon-si (KR); Sang-Mi Lee, Suwon-si (KR); Seung-Goo Baek, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/815,123

(22) Filed: Jun. 14, 2010

(30) Foreign Application Priority Data
Aug. 7, 2009 (KR) 10-2009-0072737

(51) Int. Cl. H04N 13/04

(52) U.S. Cl. 348/54; 348/E13.075

(57) ABSTRACT

A display apparatus for switching between 2-dimensional (2D) and 3-dimensional (3D) image displaying modes is disclosed. In one embodiment, the display apparatus includes: i) a display unit configured to emit light, ii) a first optical sheet configured to input the emitted light and output a first refracted light and iii) a second optical sheet configured to input the first refracted light and selectively output one of a second refracted light and a third refracted light, wherein the first optical sheet is located between the display unit and second optical sheet. The display apparatus further includes an actuator configured to move at least one of the first optical sheet and the second optical sheet between a contacting state and a separating state, wherein the first and second optical sheets contact each other at the contacting state so that the second optical sheet outputs the second refracted light, and wherein the first and second optical sheets are spaced apart from each other at the separating state so that the second optical sheet outputs the third refracted light.

### RELATED APPLICATIONS

This application claims the benefit of Korean Patent Application No. 10-2009-0072737, filed on Aug. 7, 2009, in the Korean Intellectual Property Office, the disclosure of which is incorporated herein in its entirety by reference.

### BACKGROUND

1. Field

One or more embodiments of the present invention relate to a display apparatus for switching between 2-dimensional (2D) and 3-dimensional (3D) image displaying modes, and more particularly, to a display apparatus which includes a simple structure to easily and selectively display 2D and 3D images.

2. Description of the Related Technology

A 3-dimensional (3D) image display apparatus is an apparatus for displaying a 3D image with a more realistic appearance, and may be applied in a wide range of applications for medicine, education, games etc. Since a 3D image display apparatus provides an image for a viewer's right eye and an image for the viewer's left eye, which is different from the image for the viewer's right eye, the viewer may see a 3D image due to a difference in the images seen by each eye.

### SUMMARY

One or more embodiments of the present invention include a display apparatus for selectively displaying 2-dimensional (2D) and 3-dimensional (3D) images.

One or more embodiments of the present invention include a display apparatus which includes a simple structure consisting of optical sheets and thus easily switches between 2D and 3D image displaying modes.

Another embodiment of the present invention is a display apparatus for switching between 2D and 3D image displaying modes, which includes a first optical sheet and a second optical sheet, each of which relative position is changed to a first position or a second position, wherein the first optical sheet and the second optical sheet refract image light.

Another embodiment of the present invention is a display apparatus, which includes: a display unit including a plurality of pixels emitting image light; a first optical sheet which is disposed in front of the display unit and refracts the image light emitted by the pixels; and a second optical sheet which is disposed in front of the first optical sheet and refracts image light that has penetrated the first optical sheet; wherein the first optical sheet and the second optical sheet are disposed such that relative positions of the first optical sheet and the second optical sheet are changeable, and the second optical sheet is moved to a first position and a second position, wherein when the second optical sheet is located in the first position, image light that has penetrated the second optical sheet is refracted at different angles, and when the second optical sheet is located in the second position, the light that has penetrated the second optical sheet is refracted to be parallel with each other.

The first optical sheet may include a plurality of convex lenses which are extended, and are adjacent to each other, and the second optical sheet may include a plurality of concave lenses which are extended and correspond to the convex lenses of the first optical sheet, and the first optical sheet and the second optical sheet are disposed such that the convex lenses face the concave lenses.

The convex lenses and the concave lenses each have a semi-circular cross-section.

The second optical sheet moves perpendicular to the pixels.

The display apparatus may further include an actuator that moves the second optical sheet to change the relative location of the second optical sheet with respect to the first optical sheet.

The display unit and the first optical sheet may be supported by a supporting frame, the second optical sheet is supported by a movable frame, and the actuator includes a motor installed in the supporting frame and a driving shaft that has a threaded surface and is rotated by the motor, wherein the driving shaft is screw-coupled to the second optical sheet and thus, when the motor rotates, the second optical sheet is moved to the first position or the second position.

The display unit and the first optical sheet may be supported by a supporting frame, a movable frame is coupled to the supporting frame such that a position of the movable frame is changeable, the second optical sheet is supported by the movable frame, and the actuator includes an electromagnet disposed on any one of the supporting frame and the movable frame and an attachment portion which is disposed to correspond to the electromagnet on the other one of the supporting frame and the movable frame and the attachment portion is attracted to the electromagnet due to the magnetic force of the electromagnet.

The first optical sheet and the display unit may move perpendicular to the pixels.

The first optical sheet and the second optical sheet may include a plurality of convex lenses that are extended, and are adjacent to each other, and the first optical sheet and the second optical sheet are disposed such that the convex lenses of the first optical sheet face the convex lenses of the second optical sheet.

The second optical sheet may move parallel to the first optical sheet.

Another embodiment is a display apparatus comprising: a display unit comprising a plurality of pixels which are configured to emit image light; a first optical sheet configured to refract the image light emitted by the pixels; and a second optical sheet configured to refract image light that has penetrated the first optical sheet, wherein the first optical sheet is located between the display unit and second optical sheet, wherein relative positions of the first optical sheet and the second optical sheet are changeable, and the second optical sheet is configured to move between a first position and a second position, wherein when the second optical sheet is located in the first position, image light that has penetrated the second optical sheet is refracted at different angles, and when the second optical sheet is located in the second position, the light that has penetrated the second optical sheet is refracted to be substantially parallel with each other.

In the above apparatus, the first optical sheet comprises a plurality of convex lenses which are extended and are adjacent to each other, wherein the second optical sheet comprises a plurality of concave lenses which are extended and correspond to the convex lenses of the first optical sheet, and wherein the first optical sheet and the second optical sheet are disposed such that the convex lenses face the concave lenses. In the above apparatus, the convex lenses and the concave lenses each have a semi-circular cross-section. In the above apparatus, the second optical sheet is configured to move in a direction substantially perpendicular to the pixels.

The above apparatus further comprises an actuator configured to move the second optical sheet to change the relative location of the second optical sheet with respect to the first optical sheet. The above apparatus further comprises: a supporting frame configured to support the display unit and the first optical sheet; and a movable frame configured to support the second optical sheet, wherein the actuator comprises: a motor installed in the supporting frame; and a driving shaft that has a threaded surface and is rotated by the motor, wherein the driving shaft is screw-coupled to the second optical sheet so that when the motor rotates, the second optical sheet moves between the first position and the second position.

The above apparatus further comprises: a supporting frame configured to support the display unit and the first optical sheet; and a movable frame movably coupled to the supporting frame and configured to support the second optical sheet; wherein the actuator comprises: an electromagnet disposed on one of the supporting frame and the movable frame; and an attachment portion which is disposed to correspond to the electromagnet on the other frame, wherein the attachment portion is attracted to the electromagnet by the magnetic force of the electromagnet.

In the above apparatus, the first optical sheet and the display unit are configured to move with respect to the second optical sheet in a direction substantially perpendicular to the pixels. In the above apparatus, the first optical sheet and the second optical sheet comprise a plurality of convex lenses that are extended and are adjacent to each other, and wherein the first optical sheet and the second optical sheet are disposed such that the convex lenses of the first optical sheet face the convex lenses of the second optical sheet. In the above apparatus, the convex lenses have a semi-circular cross-section. In the above apparatus, the second optical sheet is configured to move substantially parallel to the first optical sheet.

Another embodiment is a display apparatus comprising: a display unit configured to emit light; a first optical sheet configured to input the emitted light and output a first refracted light; a second optical sheet configured to input the first refracted light and selectively output one of a second refracted light and a third refracted light, wherein the first optical sheet is located between the display unit and second optical sheet; and an actuator configured to move at least one of the first optical sheet and the second optical sheet between a contacting state and a separating state, wherein the first and second optical sheets contact each other at the contacting state so that the second optical sheet outputs the second refracted light, and wherein the first and second optical sheet are spaced apart from each other at the separating state so that the second optical sheet outputs the third refracted light.

In the above apparatus, the second refracted light comprises a first-sub light and a second-sub light which are substantially parallel with each other, and wherein the display apparatus is configured to provide a two dimensional image based on the second refracted light. In the above apparatus, the third refracted light comprises a third-sub light and a fourth-sub light which are refracted at different angles, and wherein the display apparatus is configured to provide a three dimensional image based on the third-sub light and fourth-sub light which are provided to a viewer's left and right eyes, respectively. In the above apparatus, the first optical sheet comprises a plurality of convex lenses, and wherein the second optical sheet comprises a plurality of concave lenses which are substantially aligned with and correspond to the plurality of convex lenses, respectively.

Another embodiment is a display apparatus comprising: a display unit configured to emit light; a first optical sheet configured to at least partially refract the emitted light; a second optical sheet configured to input the refracted light and selectively output one of i) a parallel light and ii) a non-parallel light refracted at different angles; and means for moving at least one of the first optical sheet and the second optical sheet between a contacting state and a separating state.

In the above apparatus, the first and second optical sheets contact each other at the contacting state so that the second optical sheet outputs the parallel light to be displayed as a two dimensional image, and wherein the first and second optical sheet are spaced apart from each other at the separating state so that the second optical sheet outputs the non-parallel light to be displayed as a three dimensional image.

The above apparatus further comprises: a first frame accommodating the display unit and the first optical sheet; and a second frame accommodating the second optical sheet, wherein the moving means comprises: a motor installed in the supporting frame; and a driving shaft having a threaded surface and rotated by the motor, wherein the driving shaft is screw-coupled to the second optical sheet so that the first and second optical sheets move between the contacting state and separating state by the rotation of the motor.

The above apparatus further comprises: a first frame accommodating the display unit and the first optical sheet; and a second frame accommodating the second optical sheet, wherein the moving means comprises: an electromagnet disposed on one of the first and second frames; and an attachment portion disposed on the other frame, wherein the attachment portion is substantially aligned with and corresponds to the electromagnet so that the attachment portion is attracted to the electromagnet by the magnetic force of the electromagnet.

Still another embodiment is a method of displaying both a two dimensional (2D) image and a three dimensional (3D) image from the same display apparatus, the method comprising: placing a pair of optical sheets adjacent to a pixel display; and moving at least one of the optical sheets to switch between a 2D display mode and a 3D display mode.

### BRIEF DESCRIPTION OF THE DRAWINGS

These and/or other aspects will become apparent and more readily appreciated from the following description of embodiments, taken in conjunction with the accompanying drawings.

FIG. 1 is an exploded perspective view of constituents of a display apparatus for switching between 2-dimensional (2D) and 3-dimensional (3D) image displaying modes according to an embodiment of the present invention.

FIG. 2 is a cross-sectional view of the display apparatus of FIG. 1;

FIG. 3 is a schematic cross-sectional view of the display apparatus of FIG. 2 illustrating an operational state when the display apparatus displays a 3D image.

FIG. 4 is a schematic cross-sectional view of the display apparatus of FIG. 2 illustrating an operational state when the display apparatus of FIG. 2 displays a 2D image.

FIG. 5 is a conceptual block diagram for explaining how the constituents of the display apparatus of FIG. 1 are controlled.

FIG. 6 is a cross-sectional view of a display apparatus for switching between 2D and 3D image displaying modes according to another embodiment of the present invention.

FIG. 7 is a schematic cross-sectional view for explaining an operational state of a display apparatus for switching between 2D and 3D image displaying modes according to another embodiment of the present invention.

FIG. 8 is a schematic cross-sectional view for explaining another operational state of the display apparatus of FIG. 7.

FIG. 9 is a schematic cross-sectional view for explaining an operational state of a display apparatus for switching between 2D and 3D image displaying modes according to another embodiment of the present invention.

FIG. 10 is a schematic cross-sectional view for explaining another operational state of the display apparatus of FIG. 9.

### DETAILED DESCRIPTION

Many techniques for displaying 3D images have been developed. In particular, a lenticular sheet technique, which is realized by using a simple structure and provides a bright screen, is usually used. A lenticular sheet is an optical transmission sheet including semi-cylindrical lenses arranged in a matrix structure.

Light penetrating a semi-cylindrical lens of a lenticular sheet is divided into an image for a viewer's right eye (also referred to as a right image) and an image for a viewer's left eye (also referred to as a left image) due to a lens' optical effect. Two cameras for right and left eyes capture the right and left images. Then, when the display apparatus regularly and alternately displays the captured images on the same screen, a lenticular sheet located in front of the display apparatus induces the left and right images to be displayed in different directions and thus, a viewer may feel a 3D effect. However, the 3D display apparatuses using a lenticular sheet as described above only display a 3D image.

Hereinafter, the structure and operation of a display apparatus for switching between 2-dimensional (2D) and 3-dimensional (3D) image displaying modes according to embodiments of the present invention will be described in detail with reference to the accompanying drawings.

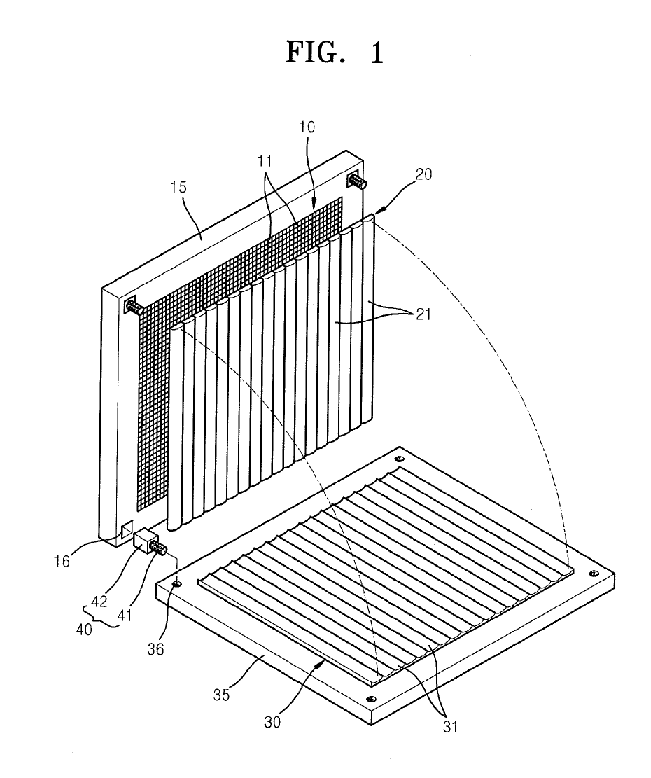

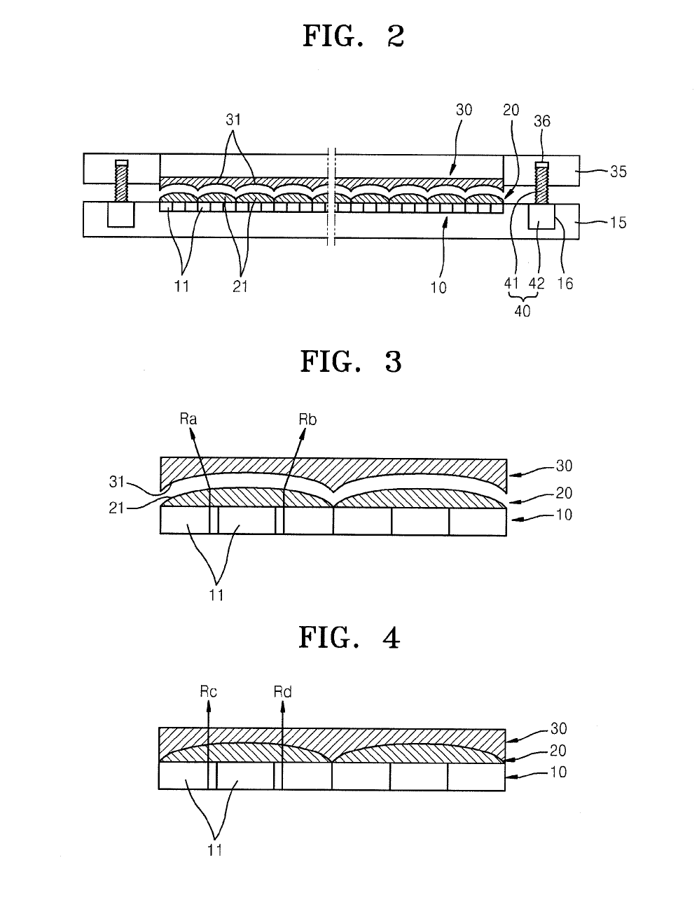

FIG. 1 is an exploded perspective view of constituents of a display apparatus for switching between 2D and 3D image displaying modes according to an embodiment of the present invention, and FIG. 2 is a cross-sectional view of the display apparatus of FIG. 1.

The display apparatus illustrated in FIGS. 1 and 2 includes a display unit 10, and a first optical sheet 20 and a second optical sheet 30 which are disposed on the surface of the display unit 10.

The display unit 10 includes a plurality of pixels 11 which emit image light. The display unit 10 may be a liquid crystal display (LCD), a plasma display panel (PDP), an electroluminescence (EL) display apparatus, or a field emission (FE) display apparatus, but is not limited thereto. The pixels 11 of the display unit 10 form an area from which image light for displaying an image is emitted.

The first optical sheet 20 may be disposed in front of the display unit 10 and refracts the image light emitted from the pixels 11. The second optical sheet 30 may be disposed in front of the first optical sheet 20 and refracts the image light that has penetrated the first optical sheet 20.

The first optical sheet 20 and the second optical sheet 30 may include a transparent material such as glass or a plastic material.

The first optical sheet 20 may include a plurality of convex lenses 21 which are substantially vertically extended and adjacent to each other. The second optical sheet 30 may include a plurality of concave lenses 31 substantially horizontally extending in correspondence to the convex lenses 21 of the first optical sheet 20. The convex lenses 21 and the concave lenses 31 have corresponding sizes and shapes, for example, semi-circular cross-sections.

In one embodiment, the first optical sheet 20 and the second optical sheet 30 described above include a lenticular lens. A lenticular lens is an array of lenses, designed so that when viewed from different viewing angles, different images are displayed. The lenticular lens is used to form a 3D image.

In regard to the lenticular lens, the width of a lens unit depends on the size of the pixels 11 of the display unit 10. The size of the pixels 11 and widths of convex and concave lenses 21 and 31 illustrated in FIGS. 1 and 2 are exaggerated for clarity and thus, are not limited thereto. For example, the pixels 11 and the convex and concave lenses 21 and 31 may be modified to have various sizes and widths.

In one embodiment, to produce a 3D image, the image light emitted from the pixels 11 is divided into left and right images by using an optical effect of the first optical sheet 20 and the second optical sheet 30. Thus, the pixels 11 and the convex and concave lenses 21 and 31 of the first optical sheet 20 and second optical sheet 30 may be disposed such that the image light is optically divided. Relative positions of the pixels 11 and the convex and concave lenses 21 and 31 and the number of pixels 11 corresponding to a unit number of the lenses 21 and 31 are also exemplary and thus, are not limited thereto.

The first optical sheet 20 and the second optical sheet 30 may be disposed such that the convex lenses 21 face the concave lenses 31. In addition, to selectively display a 3D image and a 2D image, relative positions of the first optical sheet 20 and second optical sheet 30 may be changeable. In one embodiment, the second optical sheet 30 may be fixed and the first optical sheet 20 and the display unit 10 may be movable. In another embodiment, the first optical sheet 20 may be fixed and the second optical sheet 30 may be movable. In still another embodiment, both of the first optical sheet 20 and second optical sheet 30 may be movable with respect to each other. For convenience, the description will be based on an embodiment where the second optical sheet 30 is movable.

The display apparatus may further include an actuator 40 which moves the second optical sheet 30 to change the relative position of the second optical sheet 30 with respect to the first optical sheet 20. The actuator 40 may include a motor 42, and a driving shaft 41 which is connected to the motor 42 and rotated and has a threaded surface.

In one embodiment, the display unit 10 and the first optical sheet 20 are supported by a supporting frame 15. In this embodiment, the second optical sheet 30 is supported by a movable frame 35. The movable frame 35 may be coupled to the supporting frame 15 such that the movable frame 35 is movable with respect to the supporting frame 15. When the movable frame 35 moves, the second optical sheet 30 moves with respect to the first optical sheet 20. In another embodiment, the frame 15 may be movable and the frame 35 may be fixed. In still another embodiment, both of the frames 15 and 35 may be movable with respect to each other. For convenience, the description will be based on an embodiment where the frame 35 is movable and the frame 15 is fixed.

An insertion groove 16 is formed in the supporting frame 15, and the motor 42 is inserted into the insertion groove 16. A screw groove 36 is formed in the movable frame 35, and the driving shaft 41 connected to the motor 42 is screw-coupled to the screw groove 36. Thus, when the motor 42 fixed to the supporting frame 15 rotates, the driving shaft 41 is rotated and thus, the movable frame 35 moves with respect to the supporting frame 15.

FIG. 2 is a cross-sectional view of the display apparatus of FIG. 1.

FIG. 3 is a schematic cross-sectional view of the display apparatus of FIG. 2 illustrating an operational state when the display apparatus displays a 3D image.

In one embodiment, the first optical sheet 20 and the second optical sheet 30 are disposed such that the first optical sheet 20 and the second optical sheet 30 move with respect to each other. In one embodiment, since the second optical sheet 30 moves substantially perpendicular to the pixels 11 of the display unit 10, the second optical sheet 30 moves with respect to the first optical sheet 20 such that the second optical sheet 30 is located in a first position or a second position.

FIG. 3 illustrates an operational state when the second optical sheet 30 is spaced apart from the first optical sheet 20, that is, when the second optical sheet 30 is located in the first position. In the case of the first position, image light Ra and image light Rb, which have penetrated the convex lenses 21 of the first optical sheet 20 and the concave lenses 31 of the second optical sheet 30, are refracted at different angles.

For example, a viewer's right eye may see the image light Ra emitted from the pixels 11, and a viewer's left eye may see the image light Rb emitted from the pixels 11. Thus, when the display unit 10 regularly and alternately displays images captured at different points of view with left and right cameras, an image formed by the image light Ra and the image light Rb, which have penetrated the first optical sheet 20 and the second optical sheet 30 and are refracted at different angles, may provide a 3D effect.

FIG. 4 illustrates an operational state when the second optical sheet 30 contacts the first optical sheet 20, that is, when the second optical sheet 30 is located in the second position. In the case of the second position, image light Rc and image light Rd, which have penetrated the second optical sheet 30, are refracted to be substantially parallel with each other. In the case of the second position, the display unit 10 displays an image captured at one point of view with only one camera, and thus, a viewer may see a 2D image.

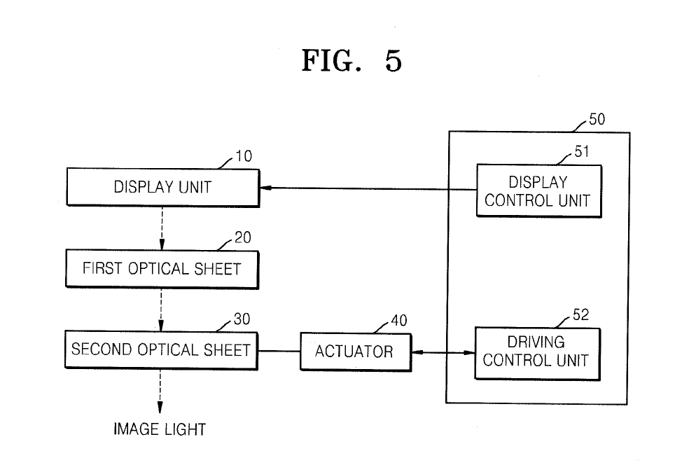

FIG. 5 is a conceptual block diagram for explaining how the constituents of the display apparatus of FIG. 1 are controlled.

The display unit 10, the first optical sheet 20, and the second optical sheet 30 are the same as described with reference to FIGS. 1 to 4. The display unit 10 displays an image controlled by a display control unit 51 of a control unit 50. According to whether the second optical sheet 30 is located with respect to the first optical sheet 20 in the first position to display a 3D image or whether the second optical sheet 30 is located with respect to the first optical sheet 20 in the second position to display a 2D image, the display control unit 51 controls the display unit 10 and a 3D image or a 2D image may be selectively displayed.

A driving control unit 52 of the control unit 50 drives the actuator 40 which moves the second optical sheet 30. The driving control unit 52 generates a control signal corresponding to a 3D image or a 2D image and thus, the actuator 40 moves the second optical sheet 30 to be located in the first position or second position.

As described above, the display apparatus includes a simple structure for switching between 2D and 3D image displaying modes.

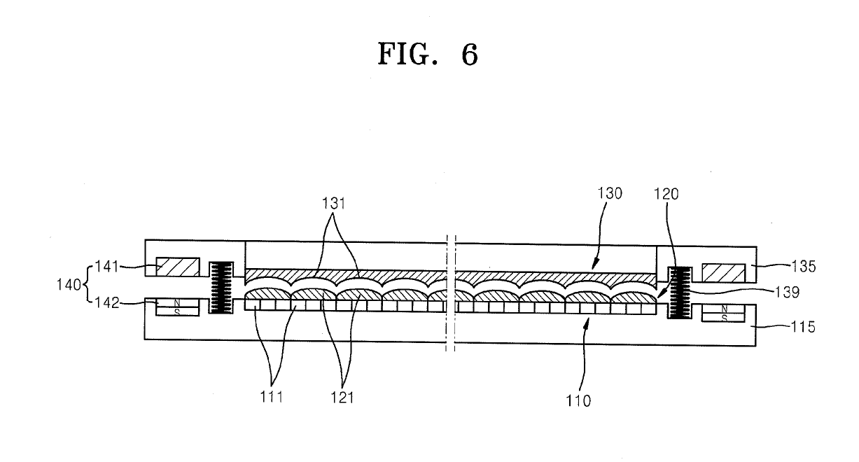

FIG. 6 is a cross-sectional view of a display apparatus for switching between 2D and 3D image displaying modes according to another embodiment of the present invention.

Referring to FIG. 6, the display apparatus according to the present embodiment includes a display unit 110 including pixels 111 emitting image light, and a first optical sheet 120 and a second optical sheet 130 which are located on the surface of the display unit 110.

As described with the display apparatus of the previous embodiment illustrated FIG. 1, the first optical sheet 120 includes convex lenses 121 that are substantially vertically extended, and the second optical sheet 130 includes concave lenses 131 corresponding to the convex lenses 121.

The first optical sheet 120 and the second optical sheet 130 may be disposed such that relative positions of the first optical sheet 120 and the second optical sheet 130 are changeable. The display apparatus may further include an actuator 140 which moves the second optical sheet 130 so that the relative position of the second optical sheet 130 with respect to the first optical sheet 120 is changeable.

In one embodiment, the actuator 140 includes an electromagnet 141 coupled to an edge of a movable frame 135, and an attachment portion 142 coupled to a supporting frame 115. The electromagnet 141 operates according to a control signal applied from outside and generates an electromagnetic force affecting the attachment portion 142, or removes the generated electromagnetic force. In one embodiment, the attachment portion 142 illustrated in FIG. 6 is a permanent magnet but is not limited thereto. For example, the attachment portion 142 may include a metal that may be attracted to the electromagnet 141 due to the generated electromagnetic force.

In addition, positions of the attachment portion 142 and the electromagnet 141 are not limited. For example, in another embodiment, the attachment portion 142 may be coupled to the movable frame 135 and the electromagnet 141 may be coupled to the supporting frame 115.

An elastic member 139 such as a spring or gas cylinder may be disposed between the supporting frame 115 and the movable frame 135. The elastic member 139 elastically supports the movable frame 135 with respect to the supporting frame 115. Thus, once the electromagnetic force which has been generated by the electromagnet 141 is removed, the movable frame 135 is separated from the supporting frame 115 due to the elastic force of the elastic member 139. In another embodiment, the actuator may include some other means which can manually or automatically move at least one of the first and second optical sheets 120 and 130 between the first position and second position.

Due to the operation of the actuator 140 as described above, the second optical sheet 130 may selectively move between the first position (or separating state) and the second position (or contacting state). In the first position, the second optical sheet 130 is spaced apart from the first optical sheet 120 such that image light that has penetrated the first optical sheet 120 and the second optical sheet 130 is refracted at different angles. In the second position, the second optical sheet 130 contacts the first optical sheet 120 such that image light that has penetrated the first optical sheet 120 and the second optical sheet 130 is refracted to be substantially parallel with each other. Due to such a simple structure, a 3D image and a 2D image may be selectively displayed.

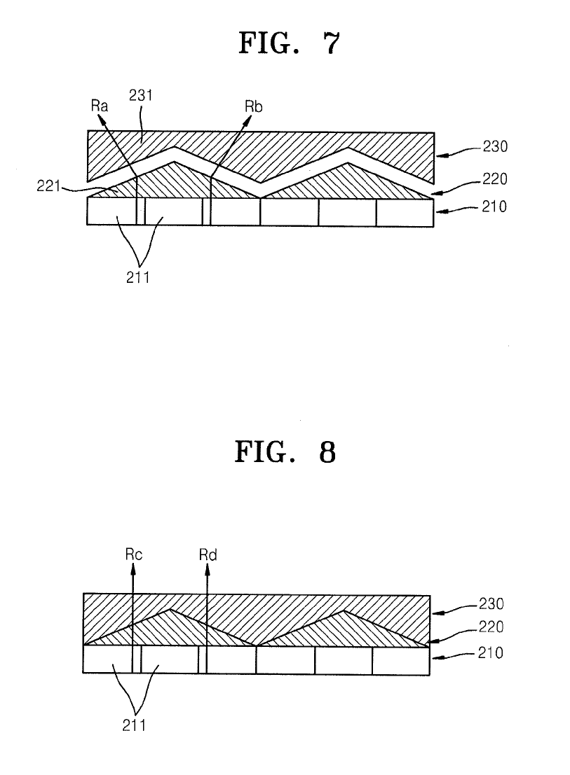

FIG. 7 is a schematic cross-sectional view for explaining an operational state of a display apparatus for switching between 2D and 3D image displaying modes according to another embodiment of the present invention, and FIG. 8 is a schematic cross-sectional view for explaining another operational state of the display apparatus of FIG. 7.

Referring to FIGS. 7 and 8, the display apparatus according to the present embodiment includes a display unit 210 including pixels 211 emitting image light, and a first optical sheet 220 and a second optical sheet 230 which are disposed on the surface of the display unit 210.

The first optical sheet 220 and the second optical sheet 230 may include a transparent material such as glass or plastic, and similar to the optical sheets illustrated in FIGS. 1 to 4, the first optical sheet 220 and the second optical sheet 230 include a plurality of lenses which are vertically extended and adjacent to each other.

The first optical sheet 220 may include a plurality of convex lenses 221 that are substantially vertically extended and adjacent to each other. The second optical sheet 230 may include a plurality of concave lenses 231 that are substantially vertically extended in correspondence to the convex lenses 221 of the first optical sheet 220. The convex lenses 221 and the concave lenses 231 may have corresponding sizes and shapes with respect to each other.

Unlike in the display apparatuses of the previous embodiments, the convex lenses 221 and the concave lenses 231 may each have an isosceles triangular cross-section. However, the shapes of the convex lenses 221 and the concave lenses 231 are not limited thereto, and may be any shape that is suitable for selectively displaying a 3D image and a 2D image. For example, the convex lenses 221 and the concave lenses 231 may have a polygonal shape such as a trapezoidal shape.

The first optical sheet 220 and the second optical sheet 230 are disposed such that the convex lenses 221 face the concave lenses 231. In order to selectively display a 3D image and a 2D image, the first optical sheet 220 and the second optical sheet 230 may be disposed such that relative positions of the first optical sheet 220 and the second optical sheet 230 are changeable. The second optical sheet 230 may move substantially perpendicular to the pixels 211 of the display unit 210, the second optical sheet 230 may move with respect to the first optical sheet 220 such that the second optical sheet 230 is located in a first position or a second position.

FIG. 7 illustrates an operational state of the display apparatus when the second optical sheet 230 is spaced apart from the first optical sheet 220, that is, when the second optical sheet 230 is located in the first position. In the case of the first position, image light Ra and image light Rb, which have penetrated the convex lenses 221 of the first optical sheet 220 and the concave lenses 231 of the second optical sheet 230, are refracted at different angles.

Thus, when the display unit 210 regularly and alternately displays images captured at different points of view, an image formed by the image light Ra and the image light Rb, which have penetrated the first optical sheet 220 and the second optical sheet 230 and are refracted at different angles, may provide a 3D effect.

FIG. 8 illustrates an operational state of the display apparatus when the second optical sheet 230 contacts the first optical sheet 220, that is, when the second optical sheet 230 is located in the second position. In the case of the second position, image light Rc and image light Rd that have penetrated the second optical sheet 230 are refracted to be substantially parallel with each other. In the case of the second position, the display unit 10 displays an image captured at one point of view with only one camera, and thus, a viewer may see a 2D image.

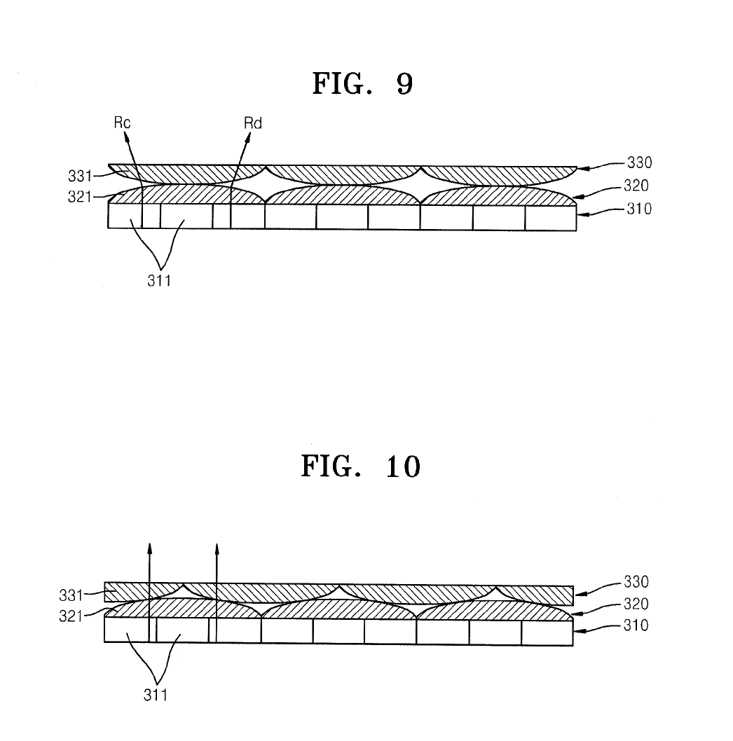

FIG. 9 is a schematic cross-sectional view for explaining an operational state of a display apparatus for switching between 2D and 3D image displaying modes according to another embodiment of the present invention, and FIG. 10 is a schematic cross-sectional view for explaining another operational state of the display apparatus of FIG. 9.

Referring to FIGS. 9 and 10, the display apparatus according to the present embodiment includes a display unit 310 including pixels 311 emitting image light, and a first optical sheet 320 and a second optical sheet 330 which are disposed on the surface of the display unit 310.

The first optical sheet 320 and the second optical sheet 330 may include a transparent material such as glass or plastic, and similar to the optical sheets illustrated in FIGS. 1 to 4, the first optical sheet 320 and the second optical sheet 330 include a plurality of lenses which are vertically extended and adjacent to each other.

The first optical sheet 320 may include a plurality of convex lenses 321 that are substantially vertically extended and adjacent to each other.

Unlike in the display apparatuses of the previous embodiments, the second optical sheet 330 may include a plurality of convex lenses 331 that are substantially vertically extended and correspond to the convex lenses 321 of the first optical sheet 320. The convex lenses 321 and the convex lenses 331 may have substantially the same size and shape. For example, the convex lenses 321 and the convex lenses 331 may each have a semi-circular cross-section. The first optical sheet 320 and the second optical sheet 330 may be disposed such that the convex lenses 321 face the convex lenses 331.

However, the shapes of the first optical sheet 320 and the second optical sheet 330 are not limited thereto and may be any shape that is suitable for selectively displaying a 3D image and a 2D image. For example, the convex lenses 321 and the concave lenses 331 may have a polygonal shape such as a triangular shape or a trapezoidal shape.

The first optical sheet 320 and the second optical sheet 330 may be disposed such that the convex lenses 321 face the convex lenses 331. In order to selectively display a 3D image and a 2D image, the first optical sheet 320 and the second optical sheet 330 are disposed such that relative locations of the first optical sheet 320 and the second optical sheet 330 are changeable. The second optical sheet 330 may move substantially parallel to the first optical sheet 320 such that the second optical sheet 330 moves into a first position or a second position.

FIG. 9 illustrates an operational state when the second optical sheet 330 and the first optical sheet 320 have substantially the same optical axis, that is, when the second optical sheet 330 is located in the first position. In the case of the first position, the image light Ra and the image light Rb, which have penetrated the convex lenses 321 of the first optical sheet 320 and the convex lenses 331 of the second optical sheet 330, are refracted at different angles.

Thus, when the display unit 310 regularly and alternately displays images captured at different points of view with left and right cameras, an image formed by the image light Ra and the image light Rb, which have penetrated the first optical sheet 20 and the second optical sheet 30 and are refracted at different angles, may provide a 3D effect.

FIG. 10 illustrates an operational state when the second optical sheet 330 and the first optical sheet 320 have different optical axes, that is, when the second optical sheet 330 is located in the second position. In the case of the second position, image light Rc and image light Rd, which have penetrated the second optical sheet 330 are refracted to be substantially parallel with each other. In the case of the second position, the display unit 310 displays an image captured at one point of view with only one camera, and thus, a viewer may see a 2D image.

As described above, according to one or more of the above embodiments of the present invention, a display apparatus for switching between 2D and 3D image displaying modes includes a simple structure including first and second optical sheets which refract image light emitted from a display unit and are movable with respect to each other and thus, a 3D image or a 2D image may be selectively displayed.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A display apparatus comprising:
a display unit comprising a plurality of pixels which are configured to emit image light;
a first optical sheet configured to refract the image light emitted by the pixels; and
a second optical sheet configured to refract image light that has penetrated the first optical sheet, wherein the first optical sheet is located between the display unit and second optical sheet;
wherein relative positions of the first optical sheet and the second optical sheet are changeable, and the second optical sheet is configured to move between a first position and a second position,
wherein when the second optical sheet is located in the first position, image light that has penetrated the second optical sheet is refracted at different angles, and when the second optical sheet is located in the second position, the light that has penetrated the second optical sheet is refracted to be substantially parallel with each other.

2. The display apparatus of claim 1, wherein the first optical sheet comprises a plurality of convex lenses which are extended and are adjacent to each other, wherein the second optical sheet comprises a plurality of concave lenses which are extended and correspond to the convex lenses of the first optical sheet, and wherein the first optical sheet and the second optical sheet are disposed such that the convex lenses face the concave lenses.

3. The display apparatus of claim 2, wherein the convex lenses and the concave lenses each have a semi-circular cross-section.

4. The display apparatus of claim 2, wherein the second optical sheet is configured to move in a direction substantially perpendicular to the pixels.

5. The display apparatus of claim 4, further comprising an actuator configured to move the second optical sheet to change the relative location of the second optical sheet with respect to the first optical sheet.

6. The display apparatus of claim 5, further comprising:
a supporting frame configured to support the display unit and the first optical sheet; and
a movable frame configured to support the second optical sheet,
wherein the actuator comprises:
a motor installed in the supporting frame; and
a driving shaft that has a threaded surface and is rotated by the motor,
wherein the driving shaft is screw-coupled to the second optical sheet so that when the motor rotates, the second optical sheet moves between the first position and the second position.

7. The display apparatus of claim 5, further comprising:
a supporting frame configured to support the display unit and the first optical sheet; and
a movable frame movably coupled to the supporting frame and configured to support the second optical sheet;
wherein the actuator comprises:
an electromagnet disposed on one of the supporting frame and the movable frame; and
an attachment portion which is disposed to correspond to the electromagnet on the other frame, wherein the attachment portion is attracted to the electromagnet by the magnetic force of the electromagnet.

8. The display apparatus of claim 2, wherein the first optical sheet and the display unit are configured to move with respect to the second optical sheet in a direction substantially perpendicular to the pixels.

9. The display apparatus of claim 1, wherein the first optical sheet and the second optical sheet comprise a plurality of convex lenses that are extended and are adjacent to each other, and wherein the first optical sheet and the second optical sheet are disposed such that the convex lenses of the first optical sheet face the convex lenses of the second optical sheet.

10. The display apparatus of claim 9, wherein the convex lenses have a semi-circular cross-section.

11. The display apparatus of claim 1, wherein the second optical sheet is configured to move substantially parallel to the first optical sheet.

12. A display apparatus comprising:
a display unit configured to emit light;
a first optical sheet configured to input the emitted light and output a first refracted light;
a second optical sheet configured to input the first refracted light and selectively output one of a second refracted light and a third refracted light, wherein the first optical sheet is located between the display unit and second optical sheet; and
an actuator configured to move at least one of the first optical sheet and the second optical sheet between a contacting state and a separating state, wherein the first and second optical sheets contact each other at the contacting state so that the second optical sheet outputs the second refracted light, and wherein the first and second optical sheet are spaced apart from each other at the separating state so that the second optical sheet outputs the third refracted light.

13. The display apparatus of claim 12, wherein the second refracted light comprises a first-sub light and a second-sub light which are substantially parallel with each other, and wherein the display apparatus is configured to provide a two dimensional image based on the second refracted light.

14. The display apparatus of claim 12, wherein the third refracted light comprises a third-sub light and a fourth-sub light which are refracted at different angles, and wherein the display apparatus is configured to provide a three dimensional image based on the third-sub light and fourth-sub light which are provided to a viewer's left and right eyes, respectively.

15. The display apparatus of claim 12, wherein the first optical sheet comprises a plurality of convex lenses, and wherein the second optical sheet comprises a plurality of concave lenses which are substantially aligned with and correspond to the plurality of convex lenses, respectively.

16. A display apparatus comprising:
a display unit configured to emit light;
a first optical sheet configured to at least partially refract the emitted light;
a second optical sheet configured to input the refracted light and selectively output one of i) a parallel light and ii) a non-parallel light refracted at different angles; and
means for moving at least one of the first optical sheet and the second optical sheet between a contacting state and a separating state.

17. The display apparatus of claim 16, wherein the first and second optical sheets contact each other at the contacting state so that the second optical sheet outputs the parallel light to be displayed as a two dimensional image, and wherein the first and second optical sheet are spaced apart from each other at the separating state so that the second optical sheet outputs the non-parallel light to be displayed as a three dimensional image

18. The display apparatus of claim 16, further comprising:
a first frame accommodating the display unit and the first optical sheet; and
a second frame accommodating the second optical sheet,
wherein the moving means comprises:
a motor installed in the supporting frame; and
a driving shaft having a threaded surface and rotated by the motor,
wherein the driving shaft is screw-coupled to the second optical sheet so that the first and second optical sheets move between the contacting state and separating state by the rotation of the motor.

19. The display apparatus of claim 16, further comprising:
a first frame accommodating the display unit and the first optical sheet; and
a second frame accommodating the second optical sheet,
wherein the moving means comprises:
an electromagnet disposed on one of the first and second frames; and
an attachment portion disposed on the other frame, wherein the attachment portion is substantially aligned with and corresponds to the electromagnet so that the attachment portion is attracted to the electromagnet by the magnetic force of the electromagnet.

20. A method of displaying both a two dimensional (2D) image and a three dimensional (3D) image from the same display apparatus, the method comprising:
placing a pair of optical sheets adjacent to a pixel display; and
moving at least one of the optical sheets to switch between a 2D display mode and a 3D display mode.
